(19) United States
(12) Patent Application Publication
(10) Pub. No.: US 2015/0272808 A1
(43) Pub. Date: Oct. 1, 2015

(54) APPARATUS FOR SPINAL COLUMN CORRECTION

(71) Applicant: Young-Jun Lee, Cheonan (KR)

(72) Inventor: Young-Jun Lee, Cheonan (KR)

(21) Appl. No.: 14/343,833

(22) PCT Filed: Dec. 6, 2013
(86) PCT No.: PCT/KR2013/011261

§ 371 Date: Mar. 7, 2014

(30) Foreign Application Priority Data
Dec. 10, 2012 (KR) 10-2012-0142535

(51) Int. Cl. A61H 1/02; A61H 1/00

(52) U.S. Cl. CPC A61H 1/0292; A61H 1/008

(57) ABSTRACT

Disclosed is an apparatus for spinal column correction, which includes one or more spinal column correction units coupled and connected to each other. Each of the spinal column correction units includes a spinal column seating portion having a groove formed so that a user's spinal column is seated thereon; spinal column acupressure portions formed at left and right sides of the spinal column seating portion to be higher than the spinal column seating portion; a back seating portion formed to have a height lower than the spinal column acupressure portions and to have a height equal to or lower than left and right ends of the spinal column seating portion for user's back to be seated when the spinal column is seated; and a support portion for supporting the spinal column seating portion, the spinal column acupressure portion, and the back seating portion at a certain level.

### TECHNICAL FIELD

The present invention relates to an apparatus for spinal column correction, and more particularly, to an apparatus of correcting a spinal column using the gravity generated by the weight of a human body without applying artificial external force.

### BACKGROUND ART

In general, as time to drive a car, to use a computer and to watch TV is increased and thus opportunity or time to sit is also increased, many persons frequently suffer from imbalance of a spinal column or herniated disk. Particularly, increased contemporaries complain of inconveniences by disorder or pain caused from a spinal column due to incorrect habits, and thus it is necessary to treat disorder or pain appropriately or to relieve symptoms.

However, although a method of artificially correcting a spinal column by applying physical force has been used in order to solve a problem caused from imbalance of the spinal column, there is a problem of inconvenience in that patients should purchase a high price medical apparatus or go to the hospital provided with a high price medical apparatus. Thus, there is a need for a simple apparatus capable of solving imbalance of a spinal column regardless of place.

Further, according to Korean Utility Model Application No. 20-2005-0017914, entitled “Apparatus for Spinal Column Correction”, although a spinal column can be corrected according to the shape of the apparatus that is integrally formed, since the shape of the spinal column varies according to a user and a degree of imbalance of the spinal column, there is a problem of restriction in use.

### DISCLOSURE

### Technical Problem

Accordingly, the present invention is conceived to solve the aforementioned problems in the prior art. An object of the present invention is to provide an apparatus for spinal column correction capable of correcting a spinal column using the gravity generated by the weight of a human body without applying artificial external force.

Another object of the present invention is to provide an apparatus for spinal column correction that can be detachably assembled and can be applied to spinal columns having various lengths and shapes through elastic coupling.

A further object of the present invention is to provide an apparatus for spinal column correction that is potable and makes it possible to be simply and conveniently installed and used regardless of place.

### Technical Solution

According to an aspect of the present invention for achieving the objects, there is provided an apparatus for spinal column correction, which includes one or more spinal column correction units coupled and connected to each other. Each of the spinal column correction units includes a spinal column seating portion having a groove formed so that a user's spinal column is seated thereon; spinal column acupressure portions formed at left and right sides of the spinal column seating portion to be higher than the spinal column seating portion, thereby forcibly arrange the spinal column on the spinal column seating portion; a back seating portion formed to have a height lower than the spinal column acupressure portions and to have a height equal to or lower than left and right ends of the spinal column seating portion for user's back to be seated when the spinal column is seated; and a support portion for supporting the spinal column seating portion, the spinal column acupressure portion, and the back seating portion at a certain level.

The apparatus may further include a coupling unit for coupling a first spinal column correction unit and a second spinal column correction unit among the spinal column correction units, wherein the coupling unit is inserted into coupling holes of the first and second spinal column correction units formed in both sides of the support portions, thereby coupling the first spinal column correction unit and the second spinal column correction unit.

The coupling unit may include a first catch portion protrudingly formed at one end of the coupling unit to be larger than a portion 108a, 108b having the maximum length of the coupling hole so that the coupling unit is a catch portion to be caught to the coupling hole of the first spinal column correction unit when the coupling unit is inserted into the coupling holes of the first and second spinal column correction units; a second catch portion formed at the other end of the coupling unit to have a shape corresponding to the coupling hole so that the first spinal column correction unit and the second spinal column correction unit have coupling force when the coupling unit is rotated after being inserted into the coupling holes of the first and second spinal column correction units, the second catch portion being formed so that a portion other than a first portion 206a and a second portion 206b is formed smaller than the first and second portions; and a connection portion formed between the first catch portion and the second catch portion so that the connection portion is positioned between the first spinal column correction unit and the second spinal column correction unit to connect the first spinal column correction unit and the second spinal column correction unit to each other when the coupling unit is inserted into the coupling holes of the first and second spinal column correction units.

Preferably, the connection portion is formed to be longer than a combined thickness of the first and second spinal column correction units, which is defined when the first spinal column correction unit and the second spinal column correction unit are coupled, so that the first spinal column correction unit and the second spinal column correction unit have elasticity when they are coupled.

Also, preferably, a length L1 of the support portion is formed to be longer than a length L2 of the back seating portion so that the first spinal column correction unit and the second spinal column correction unit have elasticity when they are coupled.

Further, preferably, a plurality of the coupling holes are formed in the respective front and rear surfaces of the support portion so that the first spinal column correction unit and the second spinal column correction unit are stably coupled.

Further, preferably, the coupling holes are formed to have the same configuration so that the first spinal column correction unit and the second spinal column correction unit are freely coupled without directivity.

Further, preferably, the coupling hole is formed so that the first and second portions 108a, 108b having a first length and a portion having a second length smaller than the first length intersect with each other, and is formed corresponding to the second catch portion of the coupling unit.

### Advantageous Effects

The present invention has an effect capable of correcting a spinal column using the gravity generated by the weight of a human body without applying artificial external force contrary to a general medical device.

The present invention also has an effect capable being detachably assembled and can be applied to spinal columns having various lengths and shapes through elastic coupling.

In addition, according to the present invention, there is an effect in that since the apparatus is potable and makes it possible to be simply and conveniently installed and used regardless of place, a user may comfortably use the apparatus to correct a spinal column.

### DESCRIPTION OF DRAWINGS

FIG. 1 is a perspective view showing a spinal column correction unit according to the present invention;

FIG. 2 is a front view showing the spinal column correction unit according to the present invention;

FIG. 3 is a perspective view showing a coupling unit according to the present invention;

FIG. 4 is a front view showing the coupling unit according to the present invention;

FIG. 5 is a view showing that the spinal column correction units and the coupling units according to the present invention are assembled;

FIG. 6 is a view illustrating that the spinal column correction units and the coupling units according to the present invention are assembled;

FIG. 7 is a view illustrating elasticity of the spinal column correction unit and the coupling unit according to the present invention;

FIG. 8 is a sectional view taken along line A-A′ of FIG. 5;

FIG. 9 is a perspective view showing an assembled state of an apparatus for spinal column correction according to the present invention; and

FIG. 10 is a side view showing the assembled state of the apparatus for spinal column correction according to the present invention.

### BEST MODE

Hereinafter, preferred embodiments of the present invention will be described in detail with reference to the accompanying drawings.

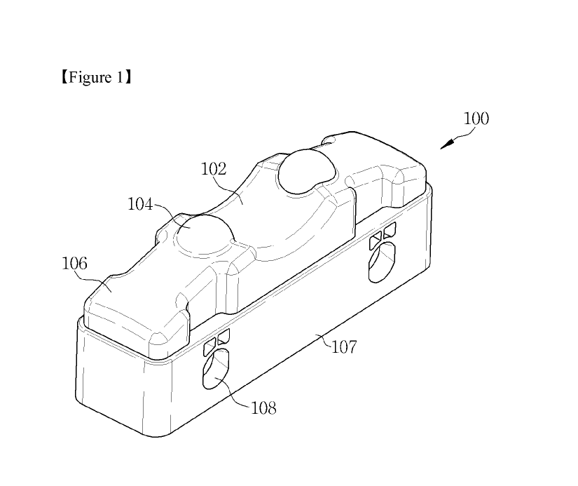

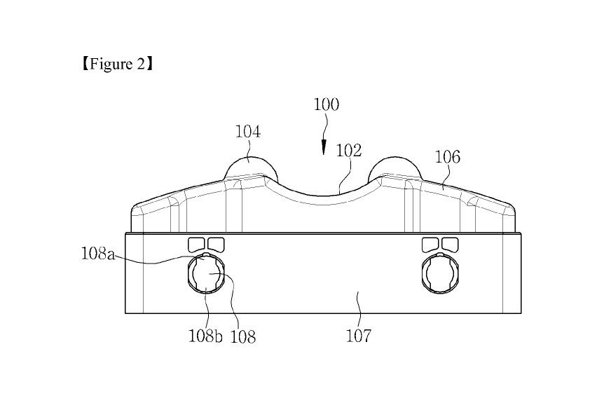

FIG. 1 is a perspective view showing a spinal column correction unit according to the present invention, and FIG. 2 is a front view showing the spinal column correction unit according to the present invention. The spinal column correction unit according to the present invention will be described with reference to FIGS. 1 and 2.

Referring to FIGS. 1 and 2, a spinal column correction unit 100 according to the present invention includes a spinal column seating portion 102, spinal column acupressure portions 104, a back seating portion 106, a support portion 107, and coupling holes 108.

The spinal column seating portion 102 is formed in the shape of a groove so that a spinal column may be seated thereon, and allows a user's spinal column to be comfortably seated on the groove when the user lies straight on his or her back. When a plurality of the spinal column correction units 100 are coupled, the user's spinal column is arranged along the shape defined by the grooves of the spinal column seating portions 102.

A pair of the spinal column acupressure portions 104 are formed at left and right sides of the spinal column seating portion 102 and convexly formed to protrude higher than the spinal column seating portion in order to forcibly arrange the seated spinal column onto the spinal column seating portion 102. In addition, an end of the spinal column acupressure portion that is in contact with a periphery of the user's spinal column is formed in the shape of a convex hemisphere in order to have acupressure effects while suitable pressure is applied without severely stimulating the periphery of the spinal column because of the user's weight.

When the user's spinal column is seated on the spinal column seating portion 102, the spinal column acupressure portions 104 press left and right of the spinal column to relax the muscles around the spinal column and the imbalanced spinal column is immersed toward the spinal column seating portion using the gravity generated by user's weight, so that the user's seated spinal column is forcibly arranged along the shape formed by the grooves of the spinal column seating portions 102 and thus the user's spinal column is balanced.

The back seating portion 106 is formed to have a height lower than the spinal column acupressure portions 104 in order to maximize spinal column immersion and acupressure effect of the spinal column acupressure portions 104, and to have a height equal to or lower than the left and right ends of the spinal column seating portion 102 in order for the user's back to be comfortably seated and maximally stretched. In more detail, it is preferred that in order for the user's back to be maximally stretched, the back seating portion 106 be formed slantingly so that one end of the back seating portion is gradually lowered than the other end of the back seating portion at which the spinal column meets the spinal column acupressure portions 104.

The support portion 107 is formed to have a certain height in order to provide the gravity generated by user's weight and to support the spinal column seating portion 102, the spinal column acupressure portions 104, and the back seating portion 106. In addition, it can be realized by making a length L1 of the support portion 107 larger than a length L2 of the back seating portion in order to have internal elasticity when a first spinal column correction unit 100a and a second spinal column correction unit 100b are coupled.

The coupling hole 108 is formed in the support portion 107 in order to coupling the spinal column correction unit and another spinal column correction unit, and is formed corresponding to a second catch portion 206 of a coupling unit 200 described later. For example, as shown in FIG. 2 in detail, the coupling hole 108 may be formed so that portions 108a and 108b having a first length (diameter) and portions having a second length smaller than the first length are formed to intersect with each other. In addition, a plurality of the coupling holes 108 may be formed at front and rear surfaces of the spinal column correction units in order to stably coupling them, and may be formed to have the same configuration so that the spinal column correction units may be freely coupled without directivity. The structure of the coupling hole will be describe in detail in the description of the coupling between the spinal column correction unit and the coupling unit that will be described later.

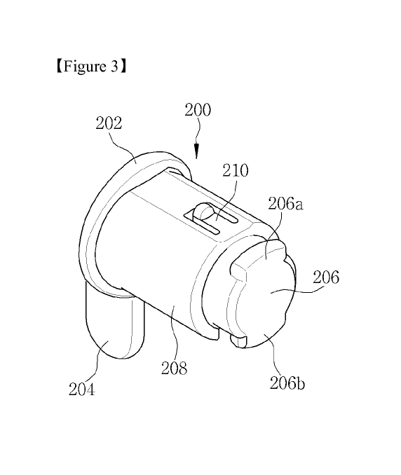

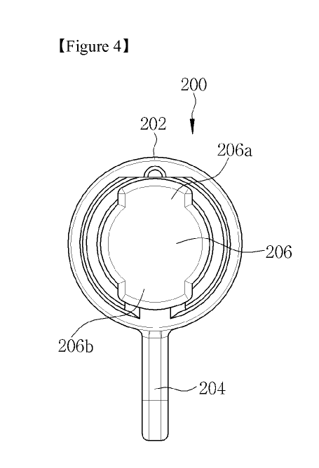

FIG. 3 is a perspective view showing the coupling unit according to the present invention, and FIG. 4 is a front view showing the coupling unit according to the present invention. The coupling unit according to the present invention will be described in detail with reference to FIGS. 3 and 4. Referring to FIGS. 3 and 4, the coupling unit 200 according to the present invention includes a first catch portion 202, a knob portion 204, the second catch portion 206, a connection portion 208, and a fastening portion 210.

The first catch portion 202 is formed at one end of the coupling unit to be larger than the portions 108a and 108b having the maximum length of the coupling hole 108 of the spinal column correction unit so that the first catch portion 202 is a catch portion.

Therefore, when the coupling unit 200 is inserted into the coupling holes of the first and second spinal column correction units 100a and 100b, the first catch portion 202 serves to be caught to the coupling hole of the first spinal column correction unit 100a.

The knob portion 204 is connected and formed at the first catch portion 202 to enable the coupling unit 200 to easily move, and functions as a knob so that the coupling unit 200 is inserted into the coupling holes of the first and second spinal column correction units 100a and 100b and can be easily moved. In addition, the knob portion 204 also functions as a knob to easily rotate the coupling unit 200 when rotating the coupling unit 200 in order to increase coupling force after it is inserted until the first catch portion 202 reaches the coupling hole.

The second catch portion 206 is formed, at the other end of the coupling unit 200, in the shape corresponding to the coupling hole 108 of the spinal column correction unit, and serves to be caught so that the first spinal column correction unit 100a and the second spinal column correction unit 100b have the coupling force when the coupling unit 200 is inserted and then rotated in the coupling holes of the first and second spinal column correction units 100a and 100b. For example, the second catch portion 206 is formed so that the first and second portions 206a and 206b have a size equal to or slightly smaller than the maximum length (diameter) of the coupling hole and the other portion may be smaller than the maximum diameter of the coupling hole and the first and second portions 206a and 206b of the second catch portion. In this case, when the coupling unit 200 is coupled to the coupling hole 108 of the spinal column correction unit, the coupling unit 200 may be configured so that it is inserted for the first and second portions 206a and 206b of the second catch portion to be aligned, in shape, with the first and second portions 108a and 108b of the coupling hole and when the coupling unit is rotated, the first and second portions of the second catch portion are caught to the minimum length (diameter) of the coupling hole in order not to be detached.

The connection portion 208 is formed between the first catch portion 202 and the second catch portion 206, and if the coupling unit 200 is inserted into the coupling holes of the first and second spinal column correction units 100a and 100b, the connection portion 208 is positioned between the first spinal column correction unit 100a and the second spinal column correction unit 100b, serving to connect the first spinal column correction unit 100a and the second spinal column correction unit 100b not to escape from each other. In addition, the connection portion 208 may be formed longer than the combined thickness of the first and second spinal column correction units 100a and 100b, which is defined when they are coupled, so that the first and second spinal column correction units 100a and 100b have elasticity when they are coupled.

The fastening portion 210 is formed in the upper end of the coupling unit 200, and is configured to be fastened to the second spinal column correction unit 100b in order to increase the coupling force between the first and second spinal column correction units 100a and 100b when the coupling unit 200 is inserted into the coupling holes of the first and second spinal column correction units 100a and 100b. In addition, the fastening portion 210 is formed to have certain elasticity, thereby making the coupling unit easily attachable and detachable.

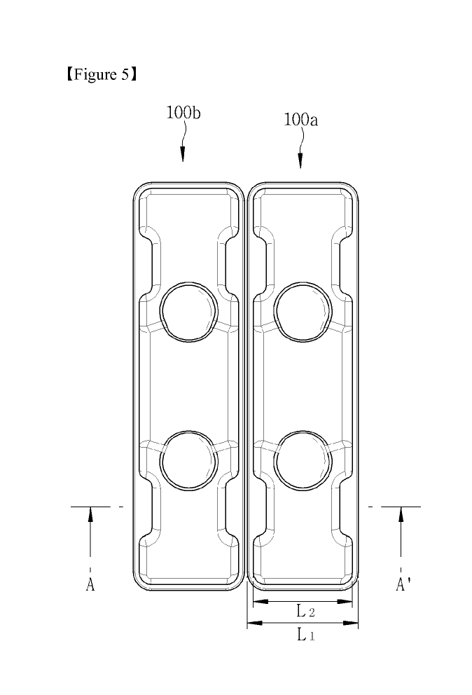

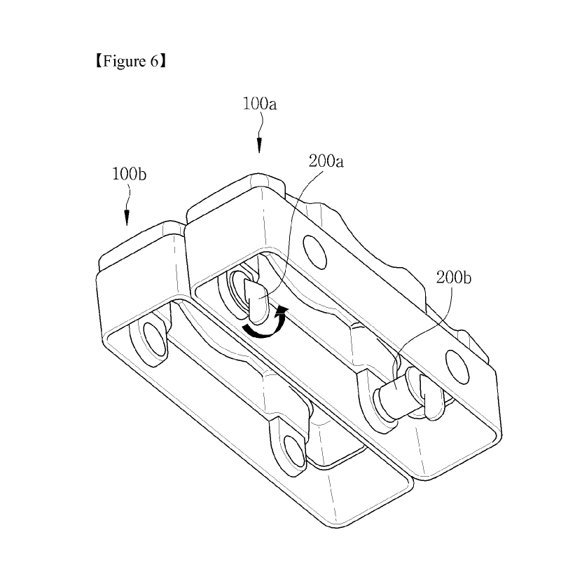

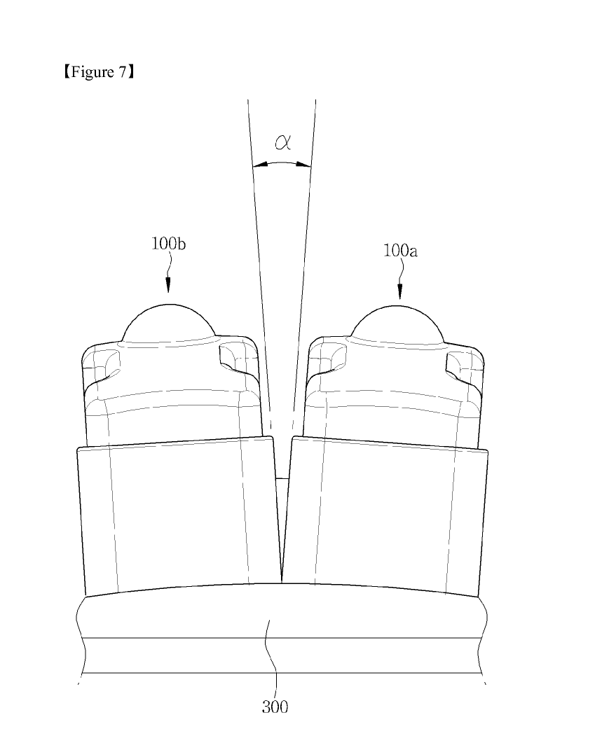

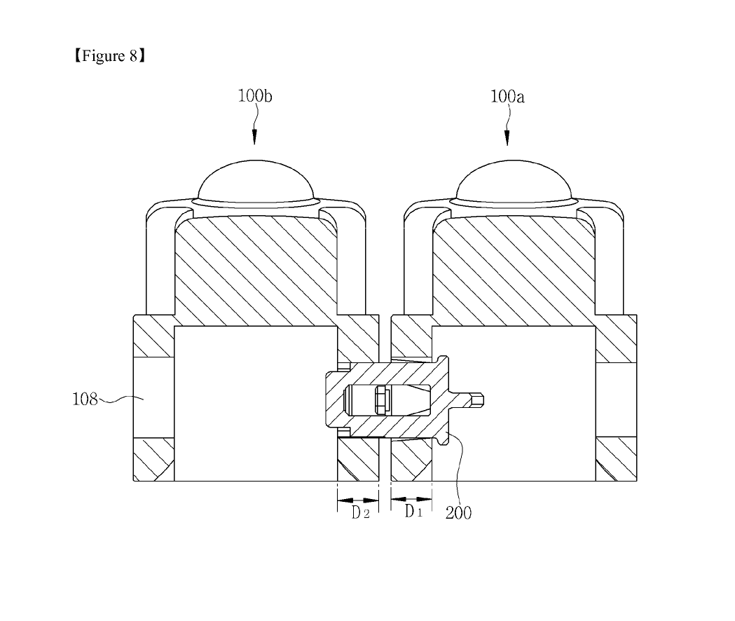

FIG. 5 is a view showing that the spinal column correction units and the coupling units according to the present invention are assembled; FIG. 6 is a view illustrating that the spinal column correction units and the coupling units according to the present invention are assembled; FIG. 7 is a view illustrating elasticity of the spinal column correction unit and the coupling unit according to the present invention; and FIG. 8 is a sectional view taken along line A-A′ of FIG. 5. Referring to FIGS. 5 to 8, the assembly of the apparatus for spinal column correction according to the present invention will be described in detail.

The apparatus for spinal column correction according to the present invention may be used by coupling a plurality of the spinal column correction units through the coupling units. FIG. 5 shows that the first spinal column correction unit 100a and the second spinal column correction unit 100b are coupled, and FIG. 6 shows that the first spinal column correction unit 100a and the second spinal column correction unit 100a are coupled through the first coupling unit 200a and the second coupling unit 200b. In a state where the coupling holes of the first spinal column correction unit 100a and the coupling holes of the second spinal column correction unit 100b adjoin one another, as shown in FIG. 6, the coupling units are inserted into the coupling holes of the first and second spinal column correction units (as shown by the coupling unit 200a), and then, the coupling units are rotated (as shown by the coupling unit 200b), thereby coupling the first spinal column correction unit 100a and the second spinal column correction unit 100b. If the coupling units 200a and 200b are inserted into the coupling holes of the first and second spinal column correction units and then rotated, the second catch portion 206 of each coupling unit is fastened into the coupling hole of the second spinal column correction unit 100b, whereby the first spinal column correction unit 100a and the second spinal column correction unit 100b are coupled. The spinal column correction units may be continuously coupled to be adjusted to user's spinal column length in the same manner.

As shown in FIG. 7, when the first spinal column correction unit 100a and the second spinal column correction unit 100b are coupled, if a physical force is applied thereto, the first spinal column correction unit 100a and the second spinal column correction unit 100b have elasticity so that they are widened or narrowed by a certain angle α. It can be realized by making the connection portion of the coupling unit have a length larger than the combined thickness D1+D2 of the first and second spinal column correction units, which is defined when they are coupled. It can also be realized by making the length L1 of the support portion of the spinal column correction unit larger than the length L2 of the back seating portion.

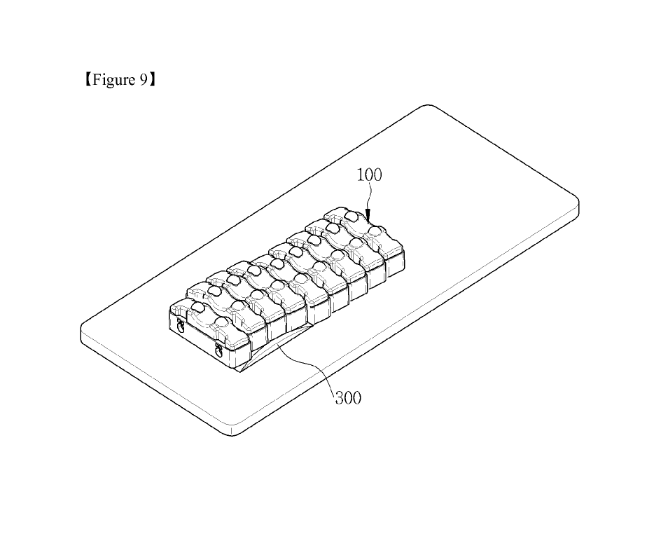

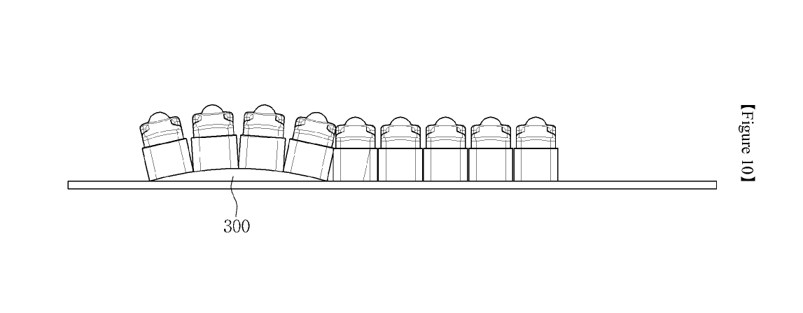

FIG. 9 is a perspective view showing an assembled state of an apparatus for spinal column correction according to the present invention; and FIG. 10 is a side view showing the assembled state of the apparatus for spinal column correction according to the present invention. An embodiment of the apparatus for spinal column correction according to the present invention will be described with reference to FIGS. 9 and 10.

Referring to FIGS. 9 and 10, if a pad 300 is put under the apparatus for spinal column correction considering a user's spinal column shape in a state where a plurality of the spinal column correction units are coupled, internal elasticity and external elasticity are generated at each spinal column correction unit by pressure of the pad 300 to make the spinal column correction units 100 curved according to the shape of the pad 300. If the user lies down so that his or her head is directed toward the upper portion of the apparatus for spinal column correction at which the curve is formed, the gravity generated by the weight is generated, thereby causing the spinal column acupressure portions 104 of the spinal column correction units to relax muscles around the user's spinal column. Further, an imbalanced spinal column is immersed toward the spinal column seating portion, so that the user's spinal column seated thereon is forcibly arranged according to the shape defined by the grooves of the spinal column seating portions 102 and thus the user's spinal column is balanced.

Meanwhile, it will be understood by those skilled in the art that various modifications can be made thereto without departing from the technical spirit or essential features of the present invention.

It should be understood by those skilled in the art that the embodiments described and illustrated above are merely for illustrative purposes and not for limitation purposes.

The true scope of the present invention should be defined by the technical spirit of the appended claims rather than the above detailed descriptions. In addition, the present invention should be interpreted to encompass all modifications and changes that would occur from the spirit and scope of the claims and the equivalence thereof.

1. An apparatus for spinal column correction, comprising:
one or more spinal column correction units coupled and connected to each other,
wherein each of the spinal column correction units comprises:
a spinal column seating portion having a groove formed so that a user's spinal column is seated thereon;
spinal column acupressure portions formed at left and right sides of the spinal column seating portion to be higher than the spinal column seating portion, thereby forcibly arrange the spinal column on the spinal column seating portion;
a back seating portion formed to have a height lower than the spinal column acupressure portions and to have a height equal to or lower than left and right ends of the spinal column seating portion for user's back to be seated when the spinal column is seated; and
a support portion for supporting the spinal column seating portion, the spinal column acupressure portion, and the back seating portion at a certain level.

2. The apparatus according to claim 1, further comprising a coupling unit for coupling a first spinal column correction unit and a second spinal column correction unit among the spinal column correction units,
wherein the coupling unit is inserted into coupling holes of the first and second spinal column correction units formed in both sides of the support portions, thereby coupling the first spinal column correction unit and the second spinal column correction unit.

3. The apparatus according to claim 2, wherein the coupling unit comprises:
a first catch portion protrudingly formed at one end of the coupling unit to be larger than a portion having the maximum length of the coupling hole so that the coupling unit is a catch portion to be caught to the coupling hole of the first spinal column correction unit when the coupling unit is inserted into the coupling holes of the first and second spinal column correction units;
a second catch portion formed at the other end of the coupling unit to have a shape corresponding to the coupling hole so that the first spinal column correction unit and the second spinal column correction unit have coupling force when the coupling unit is rotated after being inserted into the coupling holes of the first and second spinal column correction units, the second catch portion being formed so that a portion other than a first portion and a second portion is formed smaller than the first and second portions; and
a connection portion formed between the first catch portion and the second catch portion so that the connection portion is positioned between the first spinal column correction unit and the second spinal column correction unit to connect the first spinal column correction unit and the second spinal column correction unit to each other when the coupling unit is inserted into the coupling holes of the first and second spinal column correction units.

4. The apparatus according to claim 3, wherein the connection portion is formed to be longer than a combined thickness of the first and second spinal column correction units, which is defined when the first spinal column correction unit and the second spinal column correction unit are coupled, so that the first spinal column correction unit and the second spinal column correction unit have elasticity when they are coupled.

5. The apparatus according to claim 1, wherein a length of the support portion is formed to be longer than a length of the back seating portion so that the first spinal column correction unit and the second spinal column correction unit have elasticity when they are coupled.

6. The apparatus according to claim 2, wherein a plurality of the coupling holes are formed in the respective front and rear surfaces of the support portion so that the first spinal column correction unit and the second spinal column correction unit are stably coupled.

7. The apparatus according to claim 2, wherein the coupling holes are formed to have the same configuration so that the first spinal column correction unit and the second spinal column correction unit are freely coupled without directivity.

8. The apparatus according to claim 3, wherein the coupling hole is formed so that the first and second portions having a first length and a portion having a second length smaller than the first length intersect with each other, and is formed corresponding to the second catch portion of the coupling unit.
